(19) United States
(12) Patent Application Publication
(10) Pub. No.: US 2006/0259915 A1
(43) Pub. Date: Nov. 16, 2006

(54) Disk loader

(75) Inventors: Katsuyuki Yokoto, Osaka (JP); Masahiro Ando, Osaka (JP); Kazumasa Tsujihara, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/405,671

(22) Filed: Apr. 18, 2006

(30) Foreign Application Priority Data
Apr. 19, 2005 (JP) 2005-121638

(51) Int. Cl. G11B 17/04

(52) U.S. Cl. 720/624

(57) ABSTRACT

A disc loader according to the present invention is constructed in such a manner that the right side portion of a conventional disc stopper 6 is extended, and then at the leading end part thereof, i.e., to the even more anterior right of a boss 6b provided at the original right end part of the disc stopper 6, a boss 6d is provided which is formed in a substantially columnar shape and which extends downward from the bottom surface of the disc stopper 6. This boss 6d is adapted so that the distance between the boss 6d and the right side surface of the chassis 4 shown by a dimension line A becomes smaller than the radius of a small-diameter disc, that is, less than 4 cm. With this construction, the center of the disc 2 is always located at the left side of the boss 6d; therefore, the disc 2 does not become stuck between the boss on the disc stopper 6 and the right side surface of the chassis 4, and also the disc 2 is guided inwardly by the boss 6d, thereby permitting smooth centering and chucking.

This application is based on Japanese Patent Application No. 2005-121638 filed on Apr. 19, 2005, the contents of which are hereby incorporated by reference.

### BACKGROUND OF THE INVENTION

1. Field of the Invention

The present invention relates to a disc loader that holds a disc, such as a CD, a DVD, or the like, and then mounts this disc on a turntable.

2. Description of Related Arts

Known conventionally as a disc player for performing recording and reproduction on such a disc is, for example, a disc player provided with so-called a slot-in model disc loader in a form that automatically carries a disc to a predetermined position by inserting this disc through a disc insertion slot provided in the case outer surface.

Such a disc player transfers, by the disc loader described above, the disc inserted through the aforementioned insertion slot to a predetermined position on a turntable, and holds and fixes this disc on the turntable by a clamper. Then, the disc player drives the turntable into rotation to thereby rotate the disc, and writes or reads out a signal on the recording surface of the disc in rotation by a pickup.

FIG. 3 is a schematic plan view of a conventional disc loader. As shown in this figure, in the disc loader of this example, to the front of a chassis 4, a flap, not shown, is so fitted as to be freely pivotable back and forth like a seesaw, and a turntable 5 is disposed near the center thereof and a disc stopper 6 formed into a substantially long plate is disposed behind the turntable 5. On both the left and right ends of the disc stopper 6, bosses 6a and 6b are provided which are formed into a substantially columnar shape and which respectively extend downward from the bottom surface. Moreover, at the center of the disc stopper 6, a guide rib 6c is provided which serves as a guide when the disc stopper 6 slides back and forth.

Here, operation performed when a disc with a small diameter of 8 cm is inserted will be described. As shown in this figure, when the disc 2 with a small diameter is inserted through an insertion slot 4a formed at the front of the chassis 4, the disc 2 is sandwiched between the flap, not shown, and a roller 3 provided therebelow. Then, when the roller 3 rotates in this condition, the disc 2 is pulled into the chassis 4. This figure shows a case where the disc 2 with a small diameter is inserted through the right side of the insertion slot 4a.

Here, the roller 3 described above extends crosswise at the front of the chassis 4 and is capable of conveying even a large-diameter disc with a diameter of 12 cm. The roller 3 is formed into a so called substantially drum shape which is tapered in such a manner that the diameter thereof becomes gradually larger from the central portion, where the diameter is relatively small, toward both the left and the right. With this shape, the disc 2 conveyed by the rotation of the roller 3 receives a force acting inwardly relative to the direction perpendicular to the conveyance direction. Therefore, even if the disc 2 has been shifted to the left or to the right when inserted, the disc 2 is centered based on the shape of the roller 3 when conveyed by the roller 3.

Then, the disc 2 inserted through the right side position of the insertion slot 4a is conveyed inwardly of the chassis 4 and then is brought into contact with the boss 6b provided on the right end part of the disc stopper 6. In this condition, the disc 2 starts its rotation following the centering. Subsequently, the disc 2 is conveyed inwardly as described above to engage with the disc stopper 6, whereby the centering ends. The disc 2 is further conveyed to the rear side of the chassis 4, whereby the disc stopper 6 is pushed in, thereby triggering start of chucking.

At this point, since the center hole of the disc 2 is located immediately above the turntable 5, downward movement of the clamper, not shown, sandwiches the disc 2 with the turntable 5, whereby the chucking operation ends. Note that, when the disc 2 is inserted through the left side position of the insertion slot 4a, the centering and chucking operations are performed in the same manner but with the left and the right reversed in the operation of the disc 2.

As described above, in the conventional, so called slot-in model disc loader, even if the disc with a small diameter is shifted to the left or to the right when inserted, centering is performed, thereby permitting smooth chucking. Moreover, for a disc with a large diameter, the loading operation can be performed even more readily.

Besides, as a positioning mechanism included in a disc reproduction device, JP-A-2003-151194 discloses the one that performs positioning of a disc in such a manner as to sandwich the disc with a pair of freely pivotable positioning arms on the left and the right. As a pivot mechanism for such positioning arms, for example, a linkage mechanism or a gear mechanism is adopted.

JP-A-11-213505 discloses the one provided with: a plurality of sets of pins which are arranged at the inner side of the disc insertion slot with gaps therebetween becoming narrower toward a disc driving part and each of the gaps being narrower than the diameter of a large-diameter disc but wider than the diameter of a small-diameter disc; selection members which support the respective pins and which are freely transferable in the direction in which the gaps therebetween the pins become wider; and a biasing member which biases each selection member in the direction in which the gaps between the pins become narrower.

However, with the conventional structure as shown in FIG. 3 described above, in cases such as where the disc 2 with a small diameter is inserted through the extreme right position, chucking failure may occur. For example, as shown by a two-dot chain line in this figure, the disc 2 may become stuck between the boss 6b provided at the right end part of the disc stopper 6 and the right side surface of the chassis 4. In this state, the disc 2 is conveyed to the rear side of the chassis 4 without being sufficiently centered, whereby the disc stopper 6 is pushed in, thereby triggering start of chucking.

At this point, as the center hole of the disc 2 is located out of the position immediately above the turntable 5, downward movement of a clamper, not shown, does not accurately sandwich the disc 2 with the turntable 5, resulting in chucking failure. Besides, either of the constructions described in JP-A-2003-151194 and JP-A-11-213505 above is complicated and extensive, which results in cost increase and also which possibly becomes a factor triggering troubles at manufacturing or usage.

### SUMMARY OF THE INVENTION

In view of the problem described above, it is an object of the present invention to provide a disc loader capable of reliably centering and loading even a disc with a small diameter with simple construction.

To achieve the object described above, according to one aspect of the present invention, in a disc loader which sandwiches a disc inserted through an insertion port between a flap and a roller and then conveys the disc by rotation of the roller, a disc stopper is provided, and the center hole of the disc is positioned near the turntable by being engaged between bosses provided at both the left and right ends of the disc stopper. In the disc loader, an additional boss is provided at the leading end of a portion extended from the left and/or right ends of the disc stopper, and the disc is guided inwardly of the chassis by the additional boss.

The additional boss is provided at a position opposite to a disc selector, which determines whether the inserted disc has a small diameter or a large diameter, in the left and right direction with respect to the disc stopper. Moreover, the additional boss is so located as not to interfere with a large-diameter disc in a state in which the large-diameter disc is engaged with the disc stopper by being centered. Further, the distance between the additional boss and the side surface of the chassis at the side where the additional boss is provided is smaller than the radius of a small-diameter disc.

According to the invention, a disc loader capable of reliable centering and loading even a small-diameter disc with simple construction.

More specifically, the left and/or right ends of a disc stopper can be extended to be provided, at a leading end thereof, with an additional boss, by which the disc is guided inwardly of the chassis, thereby permitting smooth centering and chucking.

### DESCRIPTION OF THE DRAWING

FIG. 1 is a schematic plan view of a disc loader according to the present invention;

FIG. 2A is a bottom view of a disc stopper in the disc loader;

FIG. 2B is a rear view of the disc stopper in the disc loader;

FIG. 2C is a plan view of the disc stopper in the disc loader; and

FIG. 3 is a schematic plan view of a conventional disc loader.

### DESCRIPTION OF THE PREFERRED EMBODIMENTS

Hereinafter, an embodiment of the present invention will be described with reference to the accompanying drawings. Note that portions having the same function as that in the conventional art described above are provided with the same numerals and thus are omitted from the detailed description.

### EXAMPLE 1

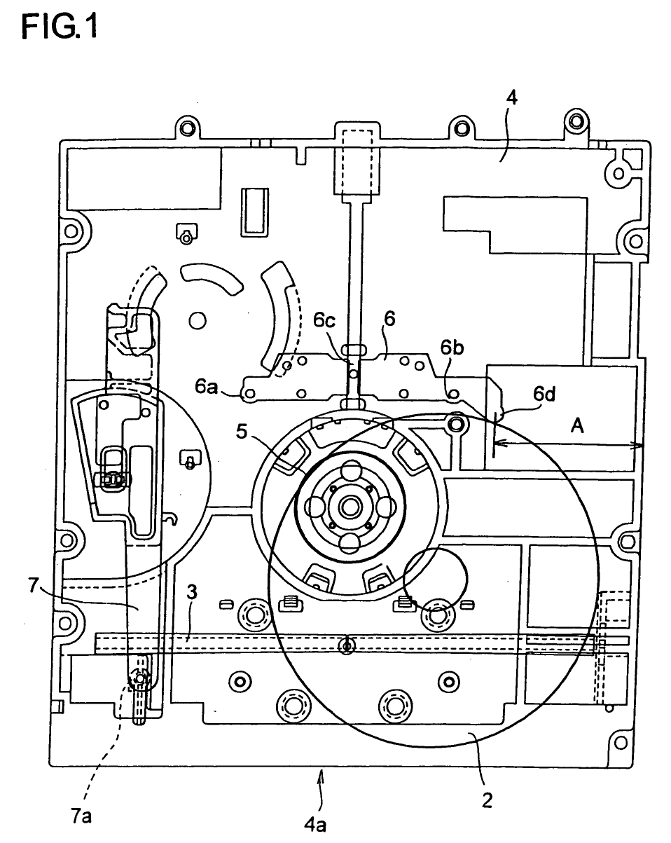

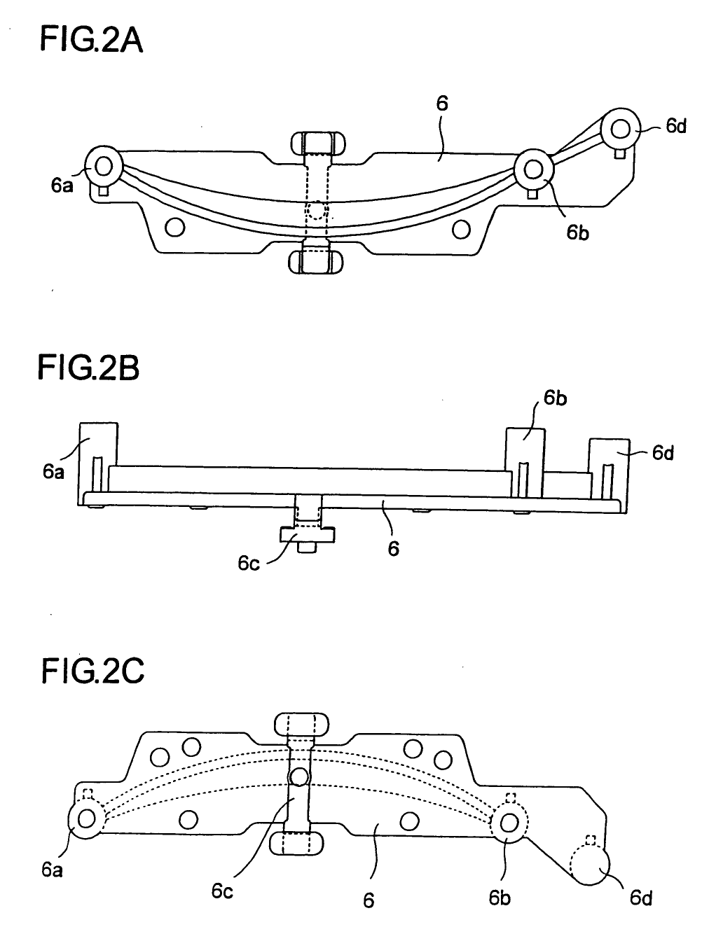

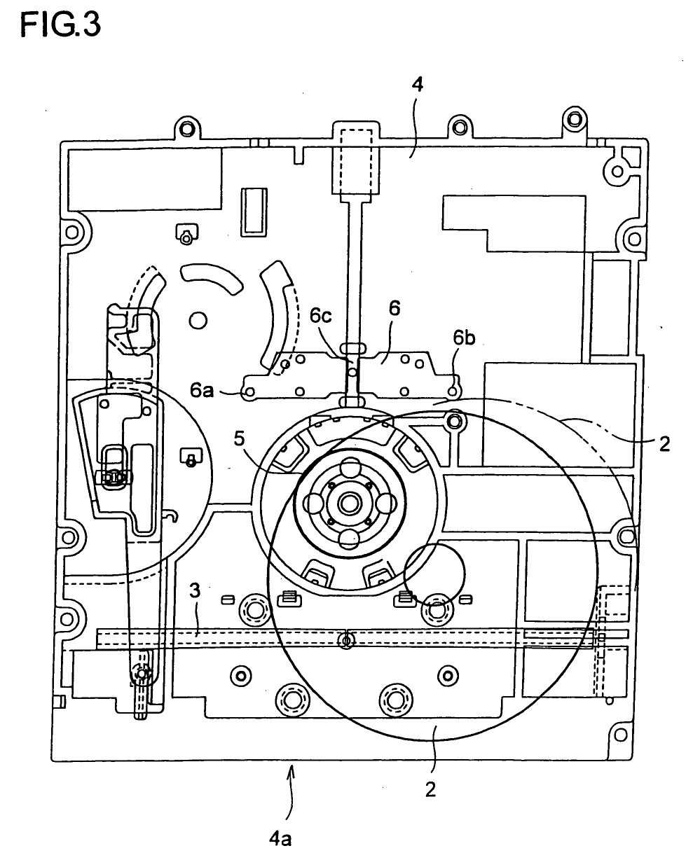

FIG. 1 is a schematic plan view of a disc loader according to the invention. FIGS. 2A to 2C are diagrams showing a disc stopper in this disc loader; FIG. 2A is a bottom view thereof, FIG. 2B is a rear view thereof, and FIG. 2C is a plan view thereof. In this example, as shown in each figure, the right side portion of the conventional disc stopper 6 is extended, and then, at the leading end part thereof, i.e., to the even more anterior right of the boss 6b provided at the original right end part of the disc stopper 6, a boss 6d is provided which is formed in a substantially columnar shape and which extends downward from the bottom surface of the disc stopper 6. This boss 6d is adapted so that the distance between the boss 6d and the right side surface of the chassis 4, shown by a dimension line A of FIG. 1, becomes smaller than the radius of a small-diameter disc, that is, less than 4 cm.

With this construction, the center of the disc 2 is always located at the left side of the boss 6d; therefore, the disc 2 does not become stuck between the boss on the disc stopper 6 and the right side surface of the chassis 4, and also the disc 2 is guided inwardly by the boss 6d, thereby permitting smooth centering and chucking. In addition, this boss 6d is so located as not to interfere with a large-diameter disc with a diameter of 12 cm which is inserted and brought into contact with the bosses 6a and 6b described above, that is, is brought into engagement with the disc stopper 6 by being centered. Therefore, the boss 6d never has no adverse influence on the centering and chucking of the large-diameter disc.

The left side portion of the disc stopper 6 may also be extended so that a boss is added thereto. However, it is assumed that, even without adding the boss at the left side, the disc 2 hardly becomes stuck between the boss 6a provided at the left end part of the disc stopper 6 and the left side surface of the chassis 4, because, as shown in FIG. 1, a disc selector 7 formed in an arm-like shape extends anteroposteriorly in the left part of the chassis 4, so that even when the disc 2 with a small diameter is inserted to the extreme left part in particular, the disc 2 is pressed back toward the center by this disc selector 7.

More specifically, at the front end part of the disc selector 7, a boss 7a is provided which is formed in a substantially columnar shape and which extends downward from the bottom surface of the disc selector 7, so that, based on the state in which the boss 7a is pressed by an inserted disc, the disc selector 7 determines whether the disc has a small diameter or a large diameter. That is, if the inserted disc has a small diameter, the disc does not make contact with the boss 7a and thus does not press it, or even if the disc makes contact with the boss 7a and thus presses it, the disc is immediately pressed back toward the center by the disc selector 7. On the other hand, if the inserted disc has a large diameter, the disc presses the boss 7a without fail and is hardly pressed back by the disc selector 7. In this manner, the disc diameter is determined by the disc selector 7.

Therefore, to add a boss to the conventional disc stopper 6, it may be provided at an opposite position in the left and right direction of the disc selector 7. When the disc diameter has been determined by the disc selector 7 based on the state in which the boss 7a is pressed by the inserted disc, the position where the disc stopper 6 is pushed in and withdrawn by the inserted disc is defined accordingly. In the state in which discs with different diameters are in contact with the bosses 6a and 6b at this position, that is, in the state in which the discs are engaged with the disc stopper 6 by being centered, the center holes of the discs are located near the turntable 5.

What is claimed is:

1. A disc loader comprising:
an insertion slot through which a disc is inserted;
a flap which is pivotable like a seesaw;
a roller which is formed in a substantially drum shape;
a turntable to which the disc is conveyed;
a disc stopper which is located at a more rear side than the turntable;
bosses which are respectively provided at both left and right ends of the disc stopper; and
an additional boss which is provided at a leading end of a portion extended from either of the left and the right ends of the disc stopper;
wherein the disc inserted through the insertion slot is sandwiched between the flap and the roller, and then the disc is conveyed to the turntable while being centered by rotation of the roller,
wherein the disc is engaged between the bosses whereby a center hole of the disc is positioned near the turntable, and
wherein the disc is guided inwardly of the chassis by the additional boss.

2. The disc loader of claim 1, further comprising:
a disc selector which is provided at either of left end and right end sides of the disc stopper and which determines whether the disc inserted through the insertion slot has a small diameter or a large diameter,
wherein the additional boss is provided at a position opposite to the disc selector in a left and right direction with respect to the disc stopper.

3. The disc loader of claim 1,
wherein the additional boss is so located as not to interfere with a large-diameter disc in a state in which the large-diameter disc is engaged with the disc stopper by being centered.

4. The disc loader of claim 1,
wherein a distance between the additional boss and a side surface of the chassis at a side where the additional boss is provided is smaller than a radius of a small-diameter disc.

5. The disc loader of claim 2,
wherein the additional boss is so located as not to interfere with a large-diameter disc in a state in which the large-diameter disc is engaged with the disc stopper by being centered.

6. The disc loader of claim 2,
wherein a distance between the additional boss and a side surface of the chassis at a side where the additional boss is provided is smaller than a radius of a small-diameter disc.

7. The disc loader of claim 3,
wherein a distance between the additional boss and a side surface of the chassis at a side where the additional boss is provided is smaller than a radius of a small-diameter disc.

8. The disc loader of claim 5,
wherein a distance between the additional boss and a side surface of the chassis at a side where the additional boss is provided is smaller than a radius of a small-diameter disc.
